(19) United States
(12) Patent Application Publication
(10) Pub. No.: US 2024/0255936 A1
(43) Pub. Date: Aug. 1, 2024

(54) AUTOMATED GUIDED VEHICLE WITH WAKEUP CIRCUIT

(71) Applicant: LINCOLN GLOBAL, INC., Santa Fe Springs, CA (US)

(72) Inventors: Dean Colwell, Lenox, MI (US); Cristiano Sarmento, Sterling Heights, MI (US)

(21) Appl. No.: 18/424,269

(22) Filed: Jan. 26, 2024

Related U.S. Application Data
(60) Provisional application No. 63/441,633, filed on Jan. 27, 2023.

(51) Int. Cl. G05B 19/418

(52) U.S. Cl. CPC G05B 19/41895; G05B 19/4185

(57) ABSTRACT

An automated guided vehicle (AGV) fleet system having a facility supervisory system and a plurality of AGVs. Each AGV has a power control module that includes: a wakeup circuit having at least one command input and at least one control output and being operable by electrical power received from a power source. The wakeup circuit includes a timer circuit and one or more parameters that can be configured via the command input, the timer circuit being coupled to the control output to change the output state of the control output in dependence on the parameter(s).

### TECHNICAL FIELD

This invention relates to automated guided vehicles (AGVs) having wireless communication capability.

### BACKGROUND

AGVs are used in commercial and industrial facilities for moving parts and inventory between physical locations in the facility. They typically include on-board (battery) power and steering systems to enable autonomous navigation using any of a number of known techniques. Some AGVs include a wireless communication device (WCD) by which the AGV may be commanded and/or polled by a computer-based supervisory system that is typically located within the same facility. Most AGVs in use today are not operated 24 hours/day, but instead are operated according to work shifts that may be dictated by other parts of the manufacturing or inventory control process, especially those involving human workers. Consequently, the AGV in such situations is manually powered up at the beginning of each shift or daily cycle, and then manually powered down at the end of that shift or cycle. This can be done using a power switch that, once pressed, provides operating power from the AGV's main battery to its circuits and, using a relay or other means, latches on that operating power until the power switch or another button is activated to shut off the AGV. The AGV circuits powered by the main battery include its steering and motor drive, as well as its WCD for wireless communication within the facility.

### SUMMARY

In accordance with one aspect of the invention, there is provided an automated guided vehicle (AGV) power control module, comprising: a wakeup circuit having at least one command input and at least one control output and being operable by electrical power received from a power source, wherein the wakeup circuit includes a timer circuit and at least one parameter that can be configured via the command input, the timer circuit being coupled to the control output to change the output state of the control output in dependence on the parameter.

In various embodiments the AGV power control module can include one or more of the following features, either alone or in any technically-feasible combination:
the timer circuit carries out a sleep/wakeup cycle for which the control output is set at a first state during a sleep portion of the cycle and is set at a second, different state during a wake portion of the cycle, and wherein the parameter is a sleep time parameter indicative of the length of time of the sleep portion of the cycle.
the timer circuit includes a wake time parameter indicative of the length of time of the wake portion of the cycle.
the second state of the control output comprises electrical power sufficient to operate a wireless communication device (WCD).
the control output comprises a WCD power output, and wherein the wakeup circuit further includes a second control output that comprises an AGV power output which can be switched between a first state and a second state that provides electrical power sufficient to operate an AGV startup circuit, and wherein the wakeup circuit operates during the sleep portion of the cycle to maintain the WCD power output and the AGV power output at their first states during which they do not provide electrical power sufficient to activate the WCD or the AGV startup circuit, respectively.
the wakeup circuit operates during the wake portion of the cycle to set the WCD power output to its second state, monitor the command input for an AGV startup command, and set the AGV power output to its second state when the AGV startup command is received.
the wakeup circuit further comprises a relay that switches the output state of the control output between a first state and a second state based on one or more commands received via the command input.
the AGV power control module further includes an AGV startup circuit input and an AGV startup circuit output, wherein the control output of the wakeup circuit and the AGV startup circuit output are logically ORed together to the AGV startup circuit input such that a power signal on either of both of the control output and the AGV startup circuit output causes a power signal to be outputted by the power control module on the AGV startup circuit input.
the wakeup circuit control output and AGV startup circuit output are logically ORed together using diodes.
the at least one command input comprises a multi-wire bus interface and the at least one parameter comprises a plurality of time/date parameters stored in the wakeup circuit and that are configurable via the bus interface.
the timer circuit comprises a software-controlled electronic processor and real time clock that can be set by the electronic processor using the time/date parameters, and wherein the wakeup circuit includes a plurality of registers each accessible by the electronic processor and each storing one of the time/date parameters.
the wakeup circuit operates in any of a plurality of operating modes including a sleep/wake mode and a shift schedule mode, wherein the wakeup circuit can be switched between the operating modes by a mode command received via the command input, and wherein the wakeup circuit is configured to receive an output control command via the command input and change the output state of the control output based on the output control command independently of the operating mode.

In accordance with another aspect of the invention, there is provided an AGV comprising the power control module described above.

In yet another aspect of the invention, there is provided an AGV fleet system comprising: a plurality of the AGVs and a non-transitory computer-readable medium having stored thereon an AGV supervisory control program that is executable by one or more electronic processors of a facility supervisory system (FSS) to carry out an AGV supervisory process for communication to, and control of, the AGVs via wireless communication from the FSS, wherein the AGV supervisory program causes the FSS to communicate with the wakeup circuit of each AGV via an AGV wireless communication device to thereby startup the AGVs from a powered down state.

A further aspect of the invention provides an automated guided vehicle (AGV) fleet system, comprising: a plurality of AGVs, each AGV having one or more power sources, a plurality of motors for driving and steering the AGV, a wireless communication device, a wakeup circuit, and an AGV controller operable by electrical power from the power source(s) and being coupled to (i) the motors to control movement and steering of the AGV, (ii) the wireless communication device for communication to and from the AGV, and (iii) the wakeup circuit for wireless startup of the AGV; and a non-transitory computer-readable medium having stored thereon an AGV supervisory control program that is executable by one or more electronic processors of a facility supervisory system (FSS) to carry out an AGV supervisory process for communication to, and control of, the AGVs via wireless communication from the FSS, wherein the AGV supervisory program causes the FSS to communicate with the wakeup circuit of each AGV via the AGV wireless communication device to thereby startup the AGVs from a powered down state.

In yet another aspect of the invention, there is provided an automated guided vehicle (AGV) fleet system, comprising: a plurality of AGVs located within a facility, each AGV having one or more power sources, a plurality of motors for driving and steering the AGV, a wireless communication device, a wakeup circuit, and an AGV controller operable by electrical power from the power source(s) and being coupled to (i) the motors to control movement and steering of the AGV, (ii) the wireless communication device for communication to and from the AGV, and (iii) the wakeup circuit for wireless startup of the AGV; and a facility supervisory system (FSS) that includes one or more FSS controllers comprising an electronic processor and memory accessible by the processor, the memory storing software comprising instructions executable by the electronic processor to carry out an AGV supervisory control process for communication and control of the AGVs, the FSS further including a plurality of wireless access points distributed around the facility and connected to the FSS controller(s), wherein the FSS controller operates under the control of the software to communicate with the wakeup circuit of each AGV via the AGV wireless communication device and one or more of the wireless access points.

A further aspect of the invention relates to a method of operating an automated guided vehicle (AGV), comprising: operating a power control module of the AGV in a sleep mode; switching from the sleep mode to a wake mode by generating a wakeup signal; automatically powering on a wireless communication device on the AGV in response to the wakeup signal while maintaining the AGV in a shutdown state; monitoring for a startup command received wirelessly by the wireless communication device; and when the startup command is received during the monitoring, automatically powering on the AGV.

In various embodiments the method can include one or more of the following features, either alone or in any technically-feasible combination:
the operating step further comprises operating the power control module in the sleep mode for a first period of time, and wherein the monitoring step further comprises monitoring for the startup command during a second period of time following the wakeup signal.
the method further includes, when the startup command is not received during the second period of time, automatically powering down the wireless communication device and returning to the sleep mode.
the method further includes carrying out repeated cycles of alternatingly operating in the sleep mode for the first period of time and in the wake mode for the second period of time until the startup command is received and the AGV is powered on.
the operating step further comprises: operating a processor of the power control module in a low power sleep mode; operating a timer circuit for the first period of time; and at the expiration of the first period of time, switching the processor out of the low power sleep mode by sending an interrupt from the timer circuit to the processor.
the switching step comprises switching to the wake mode based on a shift schedule start time and a current time provided by a real-time clock on the AGV.

In still a further aspect of the invention, there is provided a method of operating an automated guided vehicle (AGV), comprising: operating a power control module of the AGV in a sleep mode while the AGV is in a shutdown state; comparing the current time to a scheduled start time using a real-time clock in the power control module; and switching the power control module from the sleep mode to a wake mode and automatically powering on the AGV from the shutdown state when the current time has a predetermine requisite relationship to the schedule start time. In at least some embodiments the predetermined requisite relationship is that the current time equals the scheduled start time. The switching step can further comprise automatically powering on a wireless communication device on the AGV and establishing a wireless communication connection between the AGV and a facility supervisory system at a facility where the AGV is located.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 diagrammatically depicts a facility having a facility supervisory system (FSS) and a fleet of automated guided vehicles (AGVs) all constructed in accordance with an embodiment of the invention;

FIG. 2 is an electronics diagram for one of the individual AGVs of FIG. 1 containing a wakeup circuit forming part of a power control module for the AGV;

FIG. 3 is a listing of addressable registers of the wakeup circuit of FIG. 2 that are used to hold commands, parameters, and status information; and

FIG. 4 is a diagram of the facility supervisory system of FIG. 1.

### DETAILED DESCRIPTION

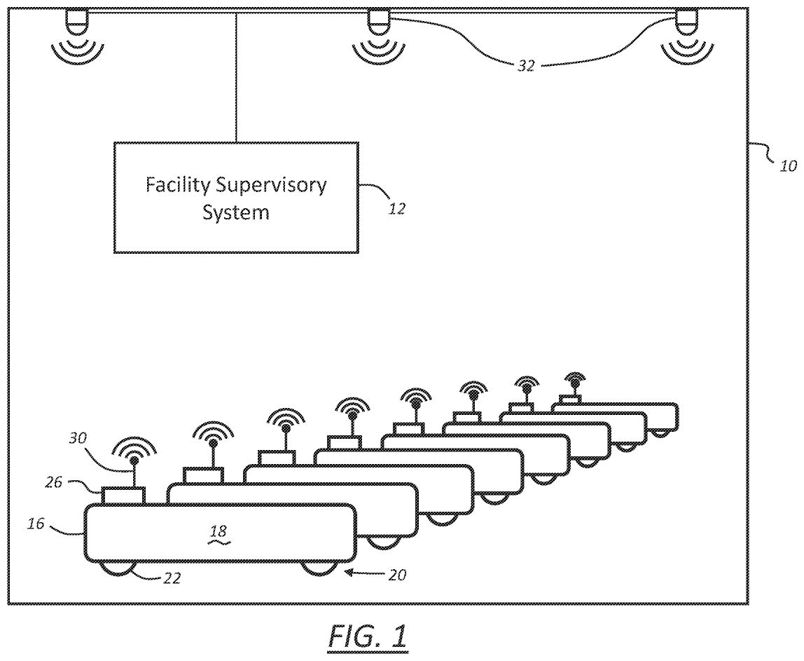

Referring to FIG. 1 there is shown diagrammatically a facility 10 having a facility supervisory system (FSS) 12 and a fleet 14 of individual automated guided vehicles (AGVs) 16. As a matter of general operation, the fleet 14 of AGVs 16 operate during any particular work shift under the coordination of the FSS 12 to move materials, inventory, and/or production workpieces between locations in the facility. One common such application is the movement of parts being manufactured between various workstations, for which the AGVs may include tooling and/or movable platforms operated by scissor lifts, rigid chains, hydraulics, etc., as is known to those skilled in the art.

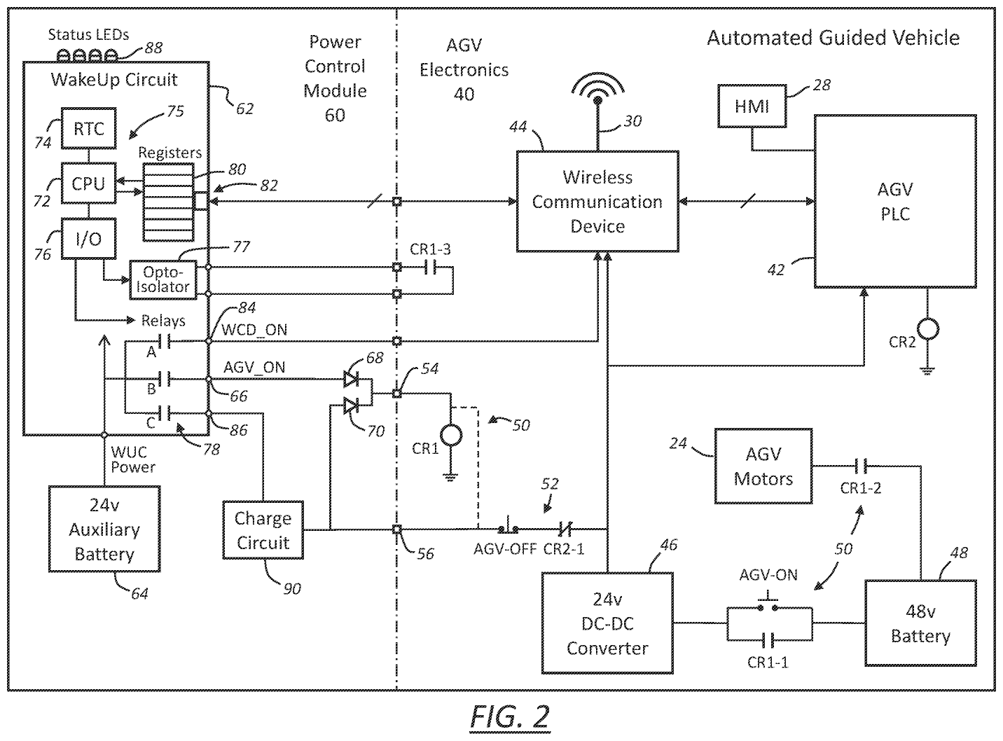

Each AGV 16 includes the basic components of a typical AGV, such as a body 18 covering a chassis supporting a plurality of wheels 20, including one or more steerable wheels 22, and one or more servo motors 24 (FIG. 2) used for steering and driving of the wheels 20 of the AGV. Various approaches for guided control of the path of the AGV 16 are known to those skilled in the art, including in-floor wire tracking and magnetic strip tracking, such as is taught in U.S. Pat. No. 8,751,142 B2. Each AGV 16 also includes at least one control panel 26 that includes a human-machine interface (HMI) 28 (FIG. 2), and one or more antennas 30 for wireless communication between the AGV and FSS 12. For that purpose, FSS 12 has at least one, but typically a plurality of wireless access points 32 spaced around the facility 10 in the vicinity of the fleet 14.

As will be described in more detail in connection with FIG. 2, each of the AGVs 16 further include AGV electronics that enable the AGV to carry out its desired functions and operability. The construction and integration of the basic AGV components noted above in connection with FIG. 1 are known to those skilled in the art.

FIG. 2 diagrammatically depicts the AGV 16 including the AGV electronics 40 and a power control module (PCM) 60 that provides AGV 16 with enhanced functionality relative to the typical AGV currently used in manufacturing and inventory handling. The components and circuitry that comprise the AGV electronics 40 is shown in FIG. 2 to the right of a dashed line, and the components and circuitry that comprise the power control module 60 are shown to the left of that dashed line.

AGV electronics 40 includes as its main electrical components, an AGV programmable logic controller (PLC) 42 that provides overall control and operation of the AGV, as well as a wireless communication device (WCD) 44 having the antenna 30 for communication between the PLC 42 and FSS 12. On-board power is supplied by a 24 v dc-dc converter 46 that gets its input power from a 48 v dc battery supply 48. The dc-dc converter 46 provides operating power to the PLC 42 and WCD 44. The 48 v battery power is supplied directly to operate the higher voltage AGV motors 24. Additional supply voltages can be developed off the 24 v supply from dc-dc converter 46 as needed or desirable for other portions of the AGV electronics 40.

AGV PLC 42 may be any suitable programmable logic controller, such as are already known for AGVs. Similarly, WCD 44 may be a networkable Wifi client module using an 802.11 protocol for communication with the access points 32 of FSS 12 and wired ethernet connections. For example, WCD 44 may be implemented using a Siemens™ SCALANCE W700 series client module. WCD 44 is connected to PLC 42 using a wired bus and bus protocol such as PROFINET.

Apart from the PLC 42, each of the other main components of the AGV electronics 40 can be addressable from FSS 12 via the WCD 44; for example, using different static IP addresses for each component. This can include the HMI 28, the WCD 44 itself, as well as other circuits not explicitly shown in FIG. 2, such as each of a plurality of magnetic sensor boards that may be included when using the guidance system of the aforementioned U.S. Pat. No. 8,751,142 B2.

Startup and shutdown of the AGV is done using an AGV operating power control circuit using relay logic that is shown using schematic symbols distributed amongst the AGV electronics 40. This AGV operating power control circuit includes an AGV startup circuit 50 and an AGV shutdown circuit 52. Startup circuit 50 includes a normally-open (NO) momentary power switch AGV-ON and a first control relay having an energizable coil CR1 controlling three separate NO contact pairs CR1-1, CR1-2, and CR1-3. Shutdown circuit 52 includes a normally-closed (NC) power interruption switch AGV-OFF as well as a second control relay having an energizable coil CR2 operated by PLC 42 to control a single NC contact pair CR2-1.

Basic operation of the startup circuit 50 is as follows. An operator at the start of the work shift activates the momentary switch AGV-ON, thereby connecting the 48 v battery power to the dc-dc converter 46, which then produces its 24 v dc output that is supplied to the PLC 42 and WCD 44. For an AGV that does not include the power control module (PCM) 60, the left side of switch AGV-OFF of the shutdown circuit 52 can be connected as shown in the dashed line to the input of relay coil CR1. Since both the shutdown components CR2-1 and AGV-OFF use normally closed contacts, the 24 v power is connected through them to the relay coil CR1, thereby energizing it and closing the three separate pole sets of contacts CR1-1, CR1-2, and CR1-3. This has the effect of latching the power on due to the (now closed) contacts CR1-1 shunting power across the momentary switch AGV-ON. This also provides operating power to the motors 24 via CR1-2. The time required for dc-dc converter 46 to power up, supply its 24 v output power, and activate coil CR1 is on the order of milliseconds, typically well under 1 second of time, thereby permitting the AGV-ON switch to mimic the response of a latching switch while also allowing electronic shutdown of the AGV. This basic operation of the startup circuit 50 (with power routed to CR1 via the dashed line connection) allows for only manual activation of startup via the switch AGV-ON.

Shutdown of the AGV 16 can be either manually by way of switch AGV-OFF or electronically by way of PLC 42 energizing the relay coil CR2. Pressing the AGV-OFF switch interrupts the 24 v power energizing relay coil CR1, thereby causing contacts CR1-1 to open, stopping the flow of power from battery 48 to the dc-dc converter 46 such that the coil CR1 will no longer receive energizing power once the AGV-ON switch is released. Contacts CR1-2 will also return to their normally-open position removing power from the motors 24. The AGV 16 therefore powers down. Shutdown can also be done similarly by using PLC 42. Activation of relay coil CR2 by PLC 42 opens the contacts CR2-1 that are in series with AGV-OFF switch and so has the same effect of causing dc-dc converter 46 to power down such that relay coil CR1 will not energize once coil CR2 is deactivated and the contacts CR2-1 then return to their normally-closed condition.

In accordance with the illustrated embodiment of the invention, PCM 60 is connected to the AGV electronics 40 which allows electronically-controlled startup of the AGV 16; i.e., without the need for manual activation of switch AGV-ON. This is done by eliminating the dashed line connection between switch AGV-OFF of the shutdown circuit 52 and relay coil CR1, and instead providing the startup circuit 50 with an AGV startup circuit input 54 and an AGV startup circuit output 56 that are used by PCM 60 to both permit manual startup via switch AGV-ON as well as automatic startup via PCM 60. Via the AGV startup circuit input 54, the PCM 60 can provide an activation or power signal to the AGV electronics 40 which turns on the AGV, similar to manually operating the AGV-ON switch. As discussed in detail below, the activation signal can be automatically generated by the PCM 60, such as at certain times of day or after predetermined time intervals, or when instructed by the FSS 12.

PCM 60 includes a wakeup circuit 62 operated off a 24 v auxiliary battery 64. Wakeup circuit 62 includes a set of 24 v relay-switched control outputs, including an AGV power output 66 that generates an AGV_ON signal and that is logically ORed together with the AGV startup circuit output 56 such that a 24 v power signal on either or both of the AGV power output 66 and the AGV startup circuit output 56 causes a power signal to be outputted by PCM 60 to the AGV startup circuit input 54. As noted above, this power signal then energizes relay coil CR1 thereby closing contacts CR1-1 and CR1-2 to thereby provide operating power to motors 24 and to the remainder of the AGV electronics via dc-dc converter 46. As shown in FIG. 2, this OR-tying of the 24 v signal line 56 originating from dc-dc converter 46 and the 24 v signal line 66 coming from wakeup circuit 62 can be done using diodes 68 and 70 connected in series with the wakeup circuit control output and the AGV startup circuit output, respectively, and with their cathodes connected together at the input end of relay coil CR1.

It will be appreciated that the startup circuit input 54 and output 56 can be implemented physically, such as is shown with PCM 60 physically separated from AGV electronics 40, or can be implemented logically where PCM 60 and AGV electronics 40 are physically integrated together; for example, by logically utilizing the dashed line connection to relay coil CR1 as the startup circuit output 56 and inserting the steering diode 70 in series in that connection.

Due to this ORed configuration of control inputs to relay coil CR1, wakeup circuit 62 can startup AGV 16 via one of its control outputs; specifically, via the AGV power output 66 on which signal AGV_ON is provided. In the illustrated embodiment, this automatic AGV startup is done using a timer circuit 75, either to carry out a process using cyclical sleep/wake modes or based on shift schedules. This approach will be described farther below. In another embodiment, automatic startup may be done using a simpler timer circuit operating in dependence on a single configurable parameter, which may be, for example, a specified time period during which the wakeup circuit operates in a sleep mode. At the expiration of this time period, the PCM 60 wakes up and changes the output state of at least one of the control outputs (e.g., AGV_ON at output 66, or WCD_ON at output 84) to thereby either initiate the AGV startup directly or wakeup only the WCD 44 and determine from the FSS 12 whether to startup the AGV 16 or return to the sleep mode. The sleep time parameter may be configured by the FSS 12 and sent to the wakeup circuit via the WCD 44.

To provide enhanced functionality, wakeup circuit 62 includes additional components and circuitry beyond the above-described automatic startup of AGV 16. It utilizes a central processing unit (CPU) 72 and a real-time clock (RTC) 74 that together form the timer circuit 75. Wakeup circuit 62 further includes an I/O controller 76, opto-isolator 77, relays 78, and registers 80 that form a part of a Modbus TCP terminal server 82. This terminal server 82 uses a physical multi-wire bus interface such as an RJ45 connector and CAT 6 or other suitable Ethernet cable connected to both the wakeup circuit 62 and an Ethernet port on WCD 44. The Modbus TCP terminal server 82 provides wakeup circuit 62 with a command input through which commands may be received, as well as parameters used by the wakeup circuit to carry out its functions. It can also be used to provide status information, either to the wakeup circuit, or from the wakeup circuit back to FSS 12 or PLC 42. In other embodiments, the command input can be more or less complex. For example, in some embodiments the command input can simply be one or more single line inputs through which the wakeup circuit receives commands and/or parameter data. And, as will be understood by those skilled in the art, these inputted commands and/or parameters can be processed and used to activate a control output of the wakeup circuit using a processor such as CPU 72 or using a gate array, or simply using relay logic.

The wakeup circuit 62 functionality can be implemented under control of CPU 72 using a program stored within the CPU's integrated flash memory. A suitable CPU may be PIC32MX274F256BT-V/MM available from Microchip Technology Inc. The programming of CPU 72 needed for wakeup circuit 62 will become apparent to those skilled in the art based on the functional descriptions below of the circuit 62 operation.

Wakeup circuit 62 operates while AGV 16 is shutdown, e.g., between work shifts. It operates so as to enable startup of the AGV automatically either upon command or according to a schedule. To do this, it runs in a low power sleep mode off auxiliary battery 64 during AGV shutdown, and then wakes up either periodically (using fixed or varying time intervals) to check for a startup command from FSS 12, or at a set time according to a scheduled start of the AGV. To do this, wakeup circuit 62, and thus, PCM 60 itself, can operate in either of two operating modes: a periodic (or cyclical) sleep/wake mode, and a shift schedule mode. For the sleep/wake mode, the wakeup circuit 62 carries out a periodic sleep/wake cycle that alternates between a sleep mode and a wake mode using the timer circuit 75 that comprises the CPU 72 and RTC 74. These sleep and wake modes are manifested by two different output states on a control output (e.g., output 66 or 84) of the wakeup circuit 62. The output state has a first state when in the sleep mode (e.g., 0 volts or high impedance) and a second, different state when in the wake mode (e.g., a low impedance 24 v powering signal). Wakeup circuit 62 continues alternating between the sleep and wake modes until a command is received during the wake mode to start the AGV 16. When this command is received, the circuit 62 responds by stopping the sleep/wake mode cycling and powering up the AGV 16. This mode uses at least two parameters, a sleep time parameter indicative of the length of a first period of time during which it operates in the sleep mode, and a wake time parameter indicative of the length of a second period of time during which it operates in the wake mode. These parameters can be specified and stored in the timer circuit 75 (e.g., in CPU 72 or RTC 74).

In the shift schedule mode, the timer circuit 75 utilizes the RTC 74 to switch from the sleep mode to the wake mode at a particular day and time stored in RTC 74. A suitable real-time clock is the RV5C387A-E2-F available from Ricoh™ and others. The CPU 72 may also access the current time from RTC 74 for various other uses, such as determining occurrence of the shutdown time for the AGV according to the shift schedule. Re-setting of the clock 74 to the current date and time can also be done programmatically by the CPU 72; for example, periodically using time and date information from an online NIST or other time server.

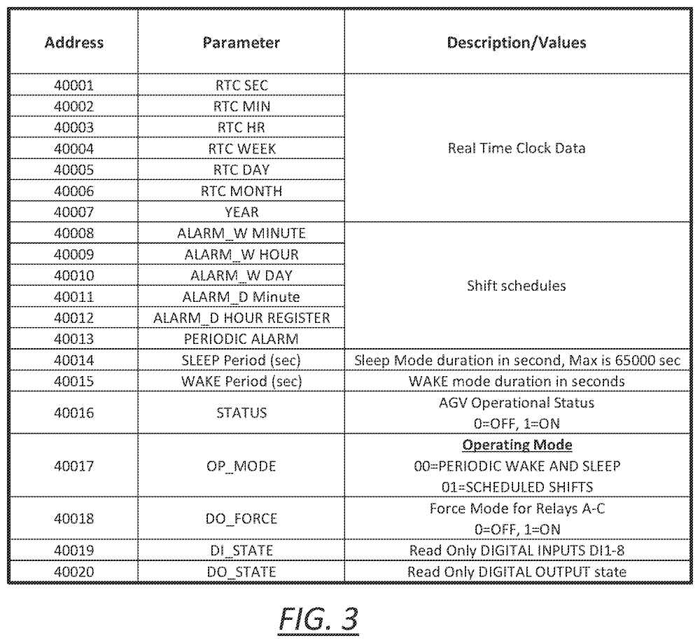

Considering the wakeup circuit 62 in more detail, data and command communication is done via the Modbus TCP terminal server 82. Commands and parameters sent from WCD 44 to the wakeup circuit 62 are stored in the terminal server registers 80 pursuant to the Modbus protocol. Similarly, status and other data can be loaded into these registers under the control of CPU 72 and reported out to PLC 42 and/or FSS 12. FIG. 3 lists example addressable registers 80 for the commands and parameters, as well as for status information that can be returned from wakeup circuit 62. Thus, for example, the sleep time and wake time parameters can be supplied from FSS 12 to registers 40014 and 40015, respectively, for subsequent reading and use by the CPU 72. The sleep time parameter may be used by CPU 72 to configure RTC 74 so that, when PCM 60 is in the sleep/wake mode, RTC 74 will provide a periodic interrupt signal to CPU 72 every xxx seconds, where xxx is the value of the sleep time parameter (and thus, is the length of the first time period). The second time period (i.e., the wake time parameter) can also be used by RTC 74 to indicate when the wake time has expired, or can be used by the CPU 72 to determine when the wake time expires after switching out of the sleep mode. In other embodiments, one or both of these parameters are hard coded into the wakeup circuit and not thereafter changeable.

Similarly, for the shift schedule operating mode, the day and time for startup of the AGV 16 can be specified by the FSS 12 using some or all of registers 40008 to 40013, and CPU 72 can configure RTC 74 to generate an alarm (e.g., CPU interrupt) when the specified date and time arrive. It is this advantage of using a real-time clock for the timer circuit that permits automatic scheduled wakeup of the AGV 16 when it is fully powered down and not able to communicate remotely.

In addition to providing parameter data, the PLC 42 and/or FSS 12 can provide commands that directly control the wakeup circuit 62 operating mode and control outputs 66, 84, and 86. This can be done by allocating some of the available registers 80 as command registers for receipt of mode commands and startup commands. The operating mode can be set using register address 40017 and the control outputs 66, 84, and 86 can be switched between their two output states (0 or 24 v) using register address 40018 by identifying the desired associated relay 78 (Relay A, B, or C respectively,) and the desired state (OFF or ON). As will be appreciated, this forced control output state change can be carried out independently of the operating mode (sleep/wake mode or shift schedule mode) and, as such, allows for remote startup of the AGV 16 regardless of the current state of wakeup circuit 62.

Available registers 80 can also be assigned as status indicators. For example, register 40016 is used to return AGV operations state (either powered OFF or powered ON). This AGV status comes from Opto-isolator 77 whose state is controlled by one of the three pole contact sets CR1-3 of the main AGV power control relay CR1. Other digital input and output states can be read and supplied back to PLC 42 and/or FSS 12 using register addresses 40019 and 40020.

These data and commands to/from wakeup circuit 62 via the Modbus TCP terminal server 82 are moved in and out of registers 80 by the CPU 72. As will be understood by those skilled in the art, I/O controller 76 is used by the CPU to write to and read from the various input/output devices (i.e., opto-isolator 77 and relays 78). Wakeup circuit 62 may also include status LEDs 88 operated by CPU 72 via I/O controller 76 to indicate operational status of the wakeup circuit 62 as well as any diagnostic information desired that can be obtained from the wakeup circuit.

Relays A and B of wakeup circuit 62 control the states of control outputs 84 and 66, respectively. Since these relays are switching 24 v power from the auxiliary battery 64, they provide sufficient electrical power to operate WCD 44 and the startup circuit 50. As indicated in FIG. 2, WCD 44 can separately receive 24 v operating power from both the dc-dc converted 46 and auxiliary battery 64 via Relay A. For the aforementioned Siemens™ SCALANCE W700 series wireless communication device, this can be done by using both its main and auxiliary power inputs. For other WCD 44 devices not having separate power inputs, the two 24 v sources can be OR-tied together using diodes, as described above in connection with startup circuit 50.

The use of these two separately controllable outputs 84 and 66 enables a stepped wakeup process in which only a portion of the AGV electronics are powered up initially so as to be able to monitor for and receive an AGV startup command and, if received, then a full powerup of the AGV can automatically carried out. Thus, the wakeup circuit 62 operates during the sleep portion of the cycle (sleep mode) to maintain the WCD_ON power output 84 and the AGV_ON power output 66 at their first states (Relays A and B open contacts) during which they do not provide electrical power sufficient to activate the WCD or the AGV startup circuit, respectively. And, the wakeup circuit 62 operates during the wake portion of the cycle (wake mode) to (i) set the WCD_ON power output 84 to its second state (Relay A contacts closed), (ii) monitor the command input for an AGV startup command (e.g., using register 40018 to listen for a DO_FORCE Relay B ON), and (iii) set the AGV power output to its second state when the AGV startup command is received.

This stepped startup of the AGV may be used in either of the sleep/wake and shift schedule operating modes. Using AGV 16 with its PCM 60, this stepped wake mode can be implemented by a method comprising:
operating the power control module of the AGV in the sleep mode;
switching from the sleep mode to the wake mode by generating a wakeup signal;
automatically powering on a wireless communication device on the AGV in response to the wakeup signal while maintaining the AGV in a shutdown state;
monitoring for a startup command received wirelessly by the wireless communication device; and
when the startup command is received during the monitoring, automatically powering on the AGV.

The switching step can be carried out using the RTC 74 to generate the wakeup signal as an interrupt that is sent to the CPU 72 when the sleep mode time period has expired (e.g., after 300 seconds). During the sleep mode, the CPU 72 can be put into its own low power sleep mode in which it stops most functions until an interrupt on its designated input pin in received. Thus, the interrupt from RTC 74 to the CPU 72 can be one that switches it out of its low power mode back into full operation. This permits the AGV electronics 40 to be fully powered down, and the PCM 60 itself to be fully powered down except for the RTC 74 and any power supply regulator operating off the auxiliary battery 64 that is needed to run the RTC.

As described above, automatically powering on the WCD 44 can be done under CPU 72 control using Relay A of the wakeup circuit while maintaining Relay B deactivated so that the AGV remains in its shutdown state. Wakeup circuit 62, now operating in the wake mode, can then monitor registers 80 for a startup command received via WCD 44 from FSS 12. And, if/when received, CPU 72 can activate Relay B to startup the AGV 16.

Additional aspects of this stepped method will be apparent based on the above description of the illustrated embodiment. For example, the method may include any of these further features:
the operating step further comprises operating the power control module in the sleep mode for a first period of time, and wherein the monitoring step further comprises monitoring for the startup command during a second period of time following the wakeup signal;
the method further comprises, when the startup command is not received during the second period of time, automatically powering down the wireless communication device and returning to the sleep mode;
the method further comprises carrying out repeated cycles of alternatingly operating in the sleep mode for the first period of time and in the wake mode for the second period of time until the startup command is received and the AGV is powered on;
the operating step further comprises:
   operating an electronic processor of the power control module in a low power sleep mode;
   operating a timer circuit for the first period of time; and
   at the expiration of the first period of time, switching the electronic processor out of the low power sleep mode by sending an interrupt from the timer circuit to the electronic processor;
the switching step comprises switching to the wake mode based on a shift schedule start time and a current time provided by a real-time clock on the AGV.

For the shift schedule operating mode, the AGV need not use the stepped startup process, but rather can be started up using the following method:
operating a power control module of the AGV in a sleep mode while the AGV is in a shutdown state;
comparing the current time to a scheduled start time using a real-time clock in the power control module; and
switching the power control module from the sleep mode to a wake mode and automatically powering on the AGV from the shutdown state when the current time has a predetermine requisite relationship to the schedule start time.

The switching step may further comprise automatically powering on a wireless communication device on the AGV and establishing a wireless communication connection between the AGV and a facility supervisory system at a facility where the AGV is located.

The predetermined requisite relationship used for determining whether to power on the AGV may be, for example, that the current time equals the scheduled start time. Alternatively, it could be some other relationship, such as starting up the AGV prior to the scheduled start time or delaying shutdown until some amount of time following the end of the shift. Because the wakeup circuit 62 can communicate at least indirectly (e.g., via FSS 12) with the PLC 42 via the Modbus and Profinet bus, it can supply the PLC 42 with a command at the appropriate time to automatically shutdown the AGV 16 via the relay CR2. Alternatively, PCM 60 could include additional circuitry (e.g., another relay 78 controlling another control output) that is put in series with the AGV-OFF switch and CR2-1 contacts to enable direct shutdown control by the PCM 60.

PCM 60 may also include a charge circuit 90 that receives 24 v power from dc-dc converter 46 via the AGV startup circuit output 56 and supplies that voltage through Relay C of the wakeup circuit 62 to the auxiliary battery 64. The charge circuit 90 may comprise a low ohm, high wattage resistor to provide a trickle charge to battery 64. Control of Relay C may be carried out by the wakeup circuit using a simple op-amp comparator that receives the battery 64 voltage as input (using a voltage divider) and a Zener diode based reference voltage to provide a binary signal back to wakeup circuit 62 that is used by CPU 72 to energize Relay C when charging of battery 64 is needed.

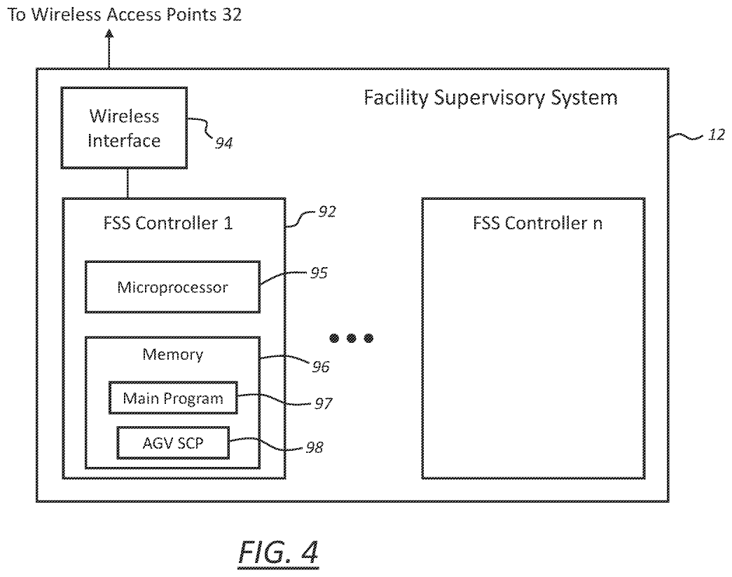

FIG. 4 depicts more detail of the FSS 12 which includes one or more FSS controllers 92 and a wireless interface 94 (e.g., a NIC card and/or router) that is used by the FSS controller(s) 92 to communicate with the AGVs 16 via the facility wireless access points 32 and AGV WDCs 44. Each controller 92 includes a microprocessor or other electronic processor 95 and computer memory 96 that includes at least one non-transitory, computer-readable medium having stored thereon a main program 97 as well as an integrated or separate AGV supervisory control program (SVP) 98. Both programs comprise computer-readable instructions and are accessible by the processor 95 to execute the programs. SVP 98 operates to receive AGV commands (e.g., startup, shutdown) as well as AGV parameters including sleep mode duration, wake mode duration, and the shift schedules, and converts that information to the commands and parameters discussed above that are used by wakeup circuit 62. This can be done individually for each AGV within the fleet 14, or can be done in groups are globally for all AGVs as needed or desired. SVP 978 can also receive status and other data supplied by wakeup circuit 62. The programming and use of SVP 98 will be apparent to those skilled in the art.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various modifications to the disclosed embodiment(s) will become apparent to those skilled in the art. For example, in other embodiments, the timer circuit may be implemented in ways other than the use of a real-time clock, electronic processor, or digital counter, such as by using a 555 timer. Also, rather than use of the auxiliary battery 64, PCM 60 may be powered by the main AGV battery 48, or some other source of electrical power. It is to be appreciated that the functionality of the PCM 60 and/or the AGV electronics 40 may also be implemented via alternative circuit topologies and/or through the use of different electrical components with respect to the embodiment(s) discussed above. For example, in certain embodiments, relays can be replaced with electronic (e.g., transistor-based) switches. All such embodiments and modifications are intended to come within the scope of the invention.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An automated guided vehicle (AGV) power control module, comprising:
a wakeup circuit having at least one command input and at least one control output and being operable by electrical power received from a power source;
wherein the wakeup circuit includes a timer circuit and at least one parameter that can be configured via the command input, the timer circuit being coupled to the control output to change the output state of the control output in dependence on the parameter.

2. The AGV power control module set forth in claim 1, wherein the timer circuit carries out a sleep/wakeup cycle for which the control output is set at a first state during a sleep portion of the cycle and is set at a second, different state during a wake portion of the cycle, and wherein the parameter is a sleep time parameter indicative of the length of time of the sleep portion of the cycle.

3. The AGV power control module set forth in claim 2, wherein the timer circuit includes a wake time parameter indicative of the length of time of the wake portion of the cycle.

4. The AGV power control module set forth in claim 2, wherein the second state of the control output comprises electrical power sufficient to operate a wireless communication device (WCD).

5. The AGV power control module set forth in claim 4, wherein the control output comprises a WCD power output, and wherein the wakeup circuit further includes a second control output that comprises an AGV power output which can be switched between a first state and a second state that provides electrical power sufficient to operate an AGV startup circuit, and wherein the wakeup circuit operates during the sleep portion of the cycle to maintain the WCD power output and the AGV power output at their first states during which they do not provide electrical power sufficient to activate the WCD or the AGV startup circuit, respectively.

6. The AGV power control module set forth in claim 5, wherein the wakeup circuit operates during the wake portion of the cycle to set the WCD power output to its second state, monitor the command input for an AGV startup command, and set the AGV power output to its second state when the AGV startup command is received.

7. The AGV power control module set forth in claim 1, wherein the wakeup circuit further comprises a relay that switches the output state of the control output between a first state and a second state based on one or more commands received via the command input.

8. The AGV power control module set forth in claim 1, further comprising an AGV startup circuit input and an AGV startup circuit output, wherein the control output of the wakeup circuit and the AGV startup circuit output are logically ORed together to the AGV startup circuit input such that a power signal on either of both of the control output and the AGV startup circuit output causes a power signal to be outputted by the power control module on the AGV startup circuit input.

9. The AGV power control module set forth in claim 8, wherein the wakeup circuit control output and AGV startup circuit output are logically ORed together using diodes.

10. The AGV power control module set forth in claim 1, wherein the at least one command input comprises a multi-wire bus interface and the at least one parameter comprises a plurality of time/date parameters stored in the wakeup circuit and that are configurable via the bus interface.

11. The AGV power control module set forth in claim 10, wherein the timer circuit comprises a software-controlled electronic processor and real time clock that can be set by the electronic processor using the time/date parameters, and wherein the wakeup circuit includes a plurality of registers each accessible by the electronic processor and each storing one of the time/date parameters.

12. The AGV power control module set forth in claim 1, wherein the wakeup circuit operates in any of a plurality of operating modes including a sleep/wake mode and a shift schedule mode, wherein the wakeup circuit can be switched between the operating modes by a mode command received via the command input, and wherein the wakeup circuit is configured to receive an output control command via the command input and change the output state of the control output based on the output control command independently of the operating mode.

13. An AGV comprising the power control module set forth in claim 1.

14. An AGV fleet system comprising:
a plurality of AGVs, each of the plurality of AGVs comprising the AGV set forth in claim 13; and
a non-transitory computer-readable medium having stored thereon an AGV supervisory control program that is executable by one or more electronic processors of a facility supervisory system (FSS) to carry out an AGV supervisory process for communication to, and control of, the AGVs via wireless communication from the FSS, wherein the AGV supervisory program causes the FSS to communicate with the wakeup circuit of each AGV via an AGV wireless communication device to thereby startup the AGVs from a powered down state.

15. An automated guided vehicle (AGV) fleet system, comprising:
a plurality of AGVs, each AGV having one or more power sources, a plurality of motors for driving and steering the AGV, a wireless communication device, a wakeup circuit, and an AGV controller operable by electrical power from the power source(s) and being coupled to (i) the motors to control movement and steering of the AGV, (ii) the wireless communication device for communication to and from the AGV, and (iii) the wakeup circuit for wireless startup of the AGV; and
a non-transitory computer-readable medium having stored thereon an AGV supervisory control program that is executable by one or more electronic processors of a facility supervisory system (FSS) to carry out an AGV supervisory process for communication to, and control of, the AGVs via wireless communication from the FSS, wherein the AGV supervisory program causes the FSS to communicate with the wakeup circuit of each AGV via the AGV wireless communication device to thereby startup the AGVs from a powered down state.

16. An automated guided vehicle (AGV) fleet system, comprising:
a plurality of AGVs located within a facility, each AGV having one or more power sources, a plurality of motors for driving and steering the AGV, a wireless communication device, a wakeup circuit, and an AGV controller operable by electrical power from the power source(s) and being coupled to (i) the motors to control movement and steering of the AGV, (ii) the wireless communication device for communication to and from the AGV, and (iii) the wakeup circuit for wireless startup of the AGV; and
a facility supervisory system (FSS) that includes one or more FSS controllers comprising an electronic processor and memory accessible by the processor, the memory storing software comprising instructions executable by the electronic processor to carry out an AGV supervisory control process for communication and control of the AGVs, the FSS further including a plurality of wireless access points distributed around the facility and connected to the FSS controller(s), wherein the FSS controller operates under the control of the software to communicate with the wakeup circuit of each AGV via the AGV wireless communication device and one or more of the wireless access points.

17. A method of operating an automated guided vehicle (AGV), comprising:
operating a power control module of the AGV in a sleep mode;
switching from the sleep mode to a wake mode by generating a wakeup signal;
automatically powering on a wireless communication device on the AGV in response to the wakeup signal while maintaining the AGV in a shutdown state;
monitoring for a startup command received wirelessly by the wireless communication device; and
when the startup command is received during the monitoring, automatically powering on the AGV.

18. The method of claim 17, wherein the operating step further comprises operating the power control module in the sleep mode for a first period of time, and wherein the monitoring step further comprises monitoring for the startup command during a second period of time following the wakeup signal.

19. The method of claim 18, further comprising, when the startup command is not received during the second period of time, automatically powering down the wireless communication device and returning to the sleep mode.

20. The method of claim 19, further comprising carrying out repeated cycles of alternatingly operating in the sleep mode for the first period of time and in the wake mode for the second period of time until the startup command is received and the AGV is powered on.

21. The method of claim 18, wherein the operating step further comprises:
operating a processor of the power control module in a low power sleep mode;
operating a timer circuit for the first period of time; and
at the expiration of the first period of time, switching the processor out of the low power sleep mode by sending an interrupt from the timer circuit to the processor.

22. The method of claim 17, wherein the switching step comprises switching to the wake mode based on a shift schedule start time and a current time provided by a real-time clock on the AGV.

23. A method of operating an automated guided vehicle (AGV), comprising:
operating a power control module of the AGV in a sleep mode while the AGV is in a shutdown state;
comparing the current time to a scheduled start time using a real-time clock in the power control module; and
switching the power control module from the sleep mode to a wake mode and automatically powering on the AGV from the shutdown state when the current time has a predetermine requisite relationship to the schedule start time.

24. The method of claim 23, wherein the predetermined requisite relationship is that the current time equals the scheduled start time.

25. The method of claim 23, wherein the switching step further comprises automatically powering on a wireless communication device on the AGV and establishing a wireless communication connection between the AGV and a facility supervisory system at a facility where the AGV is located.
